(19) United States
(12) Patent Application Publication
(10) Pub. No.: US 2020/0102525 A1
(43) Pub. Date: Apr. 2, 2020

(54) Composition

(71) Applicant: Reckitt Benckiser LLC, Parsippany, NJ (US)

(72) Inventors: Linda CHIN, Montvale, NJ (US); James DALTON, Park Ridge, NJ (US); Artur Stanislaw DOMANSKI, Montvale, NJ (US)

(21) Appl. No.: 16/616,155

(22) PCT Filed: Jun. 14, 2018
(86) PCT No.: PCT/GB2018/051642

§ 371 Date: Nov. 22, 2019

(30) Foreign Application Priority Data
Jun. 21, 2017 (GB) 1709905.2

(51) Int. Cl. C11D 17/04; C11D 11/00; C11D 17/00; C11D 3/12; E03D 9/03

(52) U.S. Cl. CPC C11D 17/046; C11D 11/0023; C11D 17/0056; E03D 2009/024; C11D 3/124; E03D 9/032; C11D 17/0039

(57) ABSTRACT

An in-the-bowl (ITB) toilet cage contains multiple pieces of a solid toilet block composition coated with silica

### TECHNICAL FIELD

The invention provides an in-the-bowl (ITB) toilet cage containing multiple pieces of a solid toilet block composition treated with silica. The silica serves to keep some or all of the pieces of the toilet block composition from agglomerating together in the bottom of the cage as a result of their contact with flushing water during a series of toilet flushing operations. This novel use of silica in combination with pieces of a toilet block composition, further in conjunction with a specially designed ITB cage, results in a surprisingly better foaming performance in the toilet bowl than prior art cages containing a single block of a toilet block compositions.

### BACKGROUND OF THE INVENTION

Everyday cleaning of the toilet bowl is a chore that no consumer enjoys. That, in part, led to the creation of in-the-bowl toilet cages (ITB) and associated toilet blocks in the 1970's. These passive cleaning devices grew in popularity in large part because the consumer did not need to interact with the toilet using a brush and a liquid toilet bowl cleaner on as frequent a basis to effect a thorough cleaning of the toilet.

ITB cages typically hang inside of the toilet bowl from the rim of the toilet by means of a hook or other attachment means and contain, for example, a cleaning composition. Upon flushing the toilet, flush water enters the cage through one or more openings, typically in the top or upper portion of the cage. Inside of the cage, the flush water contacts the cleaning composition, which usually is in a solid or gel form, and dissolves a portion of the cleaning composition in the flush water. The flush water containing the dissolved cleaning composition exits the cage via another series of openings, typically in the bottom or lower portion of the cage, and enters the toilet to provide a cleaning and/or fragrancing and/or antimicrobial benefit, depending upon the chemistry of the composition contained within the ITB cage. Such ITB cages are well known in the art and have taken on a variety of shapes and configurations over the years. These include a solid toilet block in a cage (see, e.g. European Patent No. 1,444,319 81); a gel composition in a cage (see, e.g. European Patent No. 0,864,637) and various combinations thereof.

Consumers have come to associate the presence of foam while cleaning the toilet as an indicator of increased efficacy of the cleaning composition and hence better, more thorough cleaning. To satisfy consumers' desire for the presence or creation of more foam during a cleaning operation, manufacturers of ITBs have taken a variety of routes. Some companies have increased the size and weight of the solid toilet blocks they place in an ITB (see, e.g., U.S. Pat. No. 8,051,503). Others have removed the cage entirely and produced a series of “cageless” ITBs (see, e.g. U.S. Pat. No. 8,615,820 and Canadian Patent No. 2,698,435) which have increased the weight of the block.

Consumers also associate fragrance with cleaning efficacy and the “freshness” of the toilet bowl after it has been cleaned. Typically, ITBs have provided consumers with a fragrance experience either by incorporating fragrance into the toilet block composition, into the plastic which forms the ITB cage or hook, or into a gel which is associated with the ITB cage.

While such ITBs have been successful in the marketplace and have satisfied at least in part the demands of the consumer, there is a continuing need for further improvements to existing ITBs to create substantial amounts of foam in association with the cleaning composition to provide improved technical benefits to a toilet bowl, and to also enhance the overall experience of the consumer.

It has now been surprisingly discovered by the present inventors that there is a simple, yet novel and non-obvious way to boost the amount of foam delivered by caged ITBs.

### BRIEF SUMMARY OF THE INVENTION

In a first embodiment of the invention, a known solid toilet block composition is introduced into an ITB cage; however, rather than the composition being in its usual unitary cylindrical, block or oval shape, and weight (approximately 40 grams), the composition is instead introduced into the cage as a plurality of smaller pieces each being of much smaller individual weight. During the processing of the known toilet block composition, silica (Aerosil® available from Evonik Industries, Piscataway, N.J., U.S.A.) is added to the composition. The addition of silica has the benefit of making the final toilet block composition hydrophobic and thus resistant to agglomeration when contacted by water.

It has been surprisingly observed that when such pieces of a toilet block composition are placed in an ITB cage, significantly more foam is produced than if a single toilet block is placed in an ITB cage. The addition of silica reduces or prevents the agglomeration of the toilet block pieces into a single congealed mass when contacted by toilet flush water, which otherwise reduces the amount of foaming produced and tends to block the exit orifices in the ITB cage.

### DETAILED DESCRIPTION OF THE INVENTION

To facilitate an understanding of the principles and features of the various embodiments of the present invention, various illustrative embodiments are explained herein. Although exemplary embodiments of the present invention are explained in detail, it is to be understood that other embodiments are contemplated. Accordingly, it is not intended that the present invention is limited in scope to the details of construction and arrangement of components set forth in the description, figures or examples. The present invention is capable of other embodiments and of being practiced or carried out in various ways.

As used in the specification and the appended claims, the singular forms of “a”, “an” and “the” include plural references unless the context clearly dictates otherwise. For example, reference to a component is intended also to include a plurality of components. References to a composition containing “a” constituent is intended to include other constituents in addition to the one named.

In describing the exemplary embodiments, terminology will be resorted to for the sake of clarity. It is intended that each term contemplates its broadest meaning as understood by those skilled in the art and includes all technical equivalents that operate in a similar manner to accomplish a similar purpose.

With respect to the components of the ITB, ranges may be expressed herein as from “about” or “approximately” or “substantially” one orientation and/or to “about” or “approximately” or “substantially” another particular orientation. When such a range is expressed, other exemplary embodiments include from the one particular orientation and/or to the other particular orientation.

By “comprising” or “containing” or “including” is meant that at least the named method step is present in the method, but does not preclude the presence of other method steps, even if such method steps have the same function as what is named.

It is also to be understood that the mention of one or method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the present invention are intended to be illustrative and not restrictive. Many suitable materials that would perform the same or a similar function as the materials described herein are intended to be embraced within the scope of the present invention. Such other materials not described herein can include, but are not limited to, materials that are developed after the time of the development of the present invention.

In use, a plurality of pieces of toilet block composition containing silica are placed within an ITB cage. In a preferred embodiment, approximately forty (36) pieces of the composition weighing approximately 0.95 grams each, and measuring 11 mm in diameter are added to the cage. Details of the cage are described below. The cage is suspended inside of the toilet bowl from the rim of the bowl and the toilet is then flushed. During flushing, water enters the cage through apertures in the top portion of the cage. As the water enters the cage it contacts the pieces of the toilet block composition and dissolves a quantity thereof. The water inside of the cage follows a tortuous route around the pieces of toilet block composition. As the flushing action continues, the water, with the dissolved part of the toilet block composition, floods back out of the apertures in the lower section of the cage and is carried down into the toilet bowl where the dissolved surfactants in the toilet block composition create a surprising amount of foam and carries out a technical benefit such as a cleaning and/or deodorizing and/or disinfecting action it has been observed that there is a noticeable increase in the amount of foam produced.

The cage, toilet block composition and silica are further described in detail below such that the invention may be practised without undue experimentation by one of ordinary skill in the art.

### I. CAGE

The cage is preferably constructed of a polymer, preferably polypropylene.

The cage generally comprises an upper section and a lower section. The upper section preferably has a plurality of apertures for the ingress of flushing water and the lower section preferably has a plurality of apertures for the egress of flushing water. The apertures have a preferred size of between 1 to 6 mm. The apertures may be of any shape but are preferably circular. The apertures may have any arrangement but are preferably in rows of ten evenly spaced along the cage. This arrangement (together with the preferred size) was found to enable rapid water egress from the cage (more rapid than current commercial cages).

The cage is intended to be suspended from the rim of a toilet bowl by means of a hook so as to be in the path of the flushing water. The cage may additionally/alternatively be attached to the inside wall of the toilet bowl in the path of the flushing water by other suitable means such as a suction cup.

Generally the cage has an arcuate form such that it abuts the curvature of the toilet bowl wall and captures a suitable quantity of the flush water. Disposed inside of the cage are pieces of the solid toilet block composition, as hereinafter described.

Preferably the upper section and the lower section of the cage are locked or sealed together after the introduction of the toilet block composition so that the cage cannot be opened, accidentally or otherwise, by a consumer.

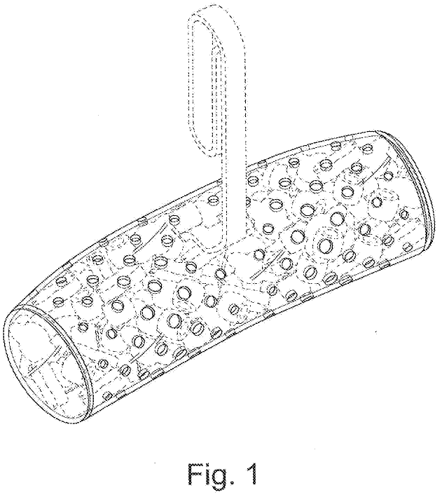

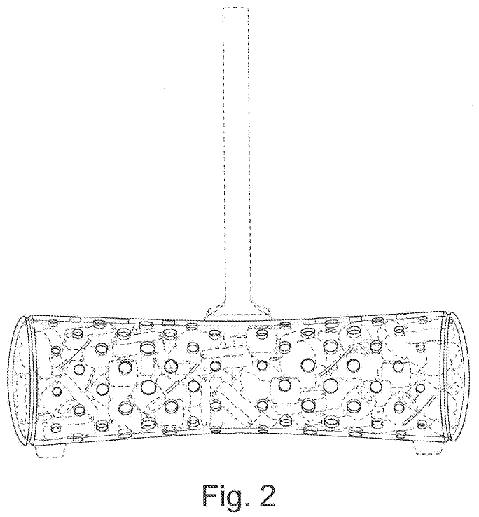

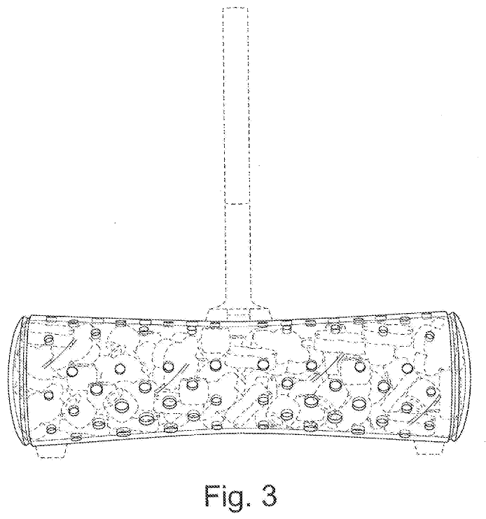

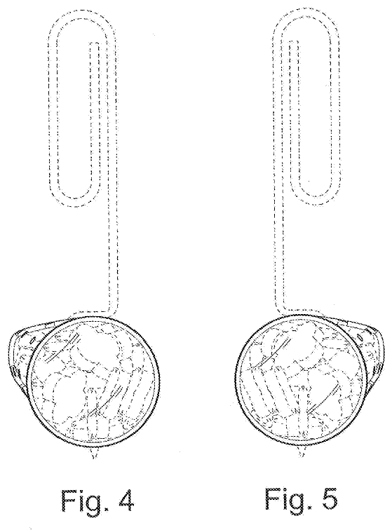

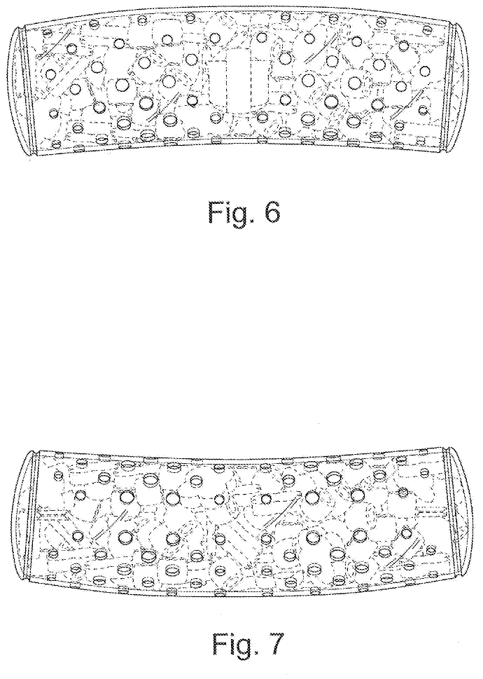

The cage is depicted in FIGS. 1 to 7.

The cage (1) is constructed of a polymer, preferably polypropylene. The cage (1) comprises a tubular section (2) with terminal lids (3). The tubular section (2) has a plurality of apertures (4) for the ingress and egress of flushing water. The cage (1) is suspended from the rim of a toilet bowl by means of a hook (8) so as to be in the path of the flushing water. The cage (1) may also be attached to the inside wall of the toilet bowl in the path of the flushing water by other means such as a suction cup (not depicted). Disposed inside of the cage (1) are pieces of the solid toilet block composition (9). Preferably the tubular section (2) with terminal lids (3) are locked or sealed together after the introduction of the toilet block composition so that the cage cannot be opened, accidentally or otherwise, by a consumer.

Although a particular ITB cage is described as illustrative, the invention is not limited to this particular embodiment of a cage. Any ITB cage containing apertures for the ingress and egress of flushing water wherein the cage contains pieces of a toilet block composition in conjunction with a plurality of beads, is deemed to be within the scope of the invention.

### II. TOILET BLOCK COMPOSITION

Without wishing to be bound by theory, it is believed that any toilet block composition containing foaming surfactants would benefit from the invention and if configured into smaller pieces to those described herein and introduced to an ITB cage, the result would be a readily noticeable increase in the amount of foaming produced during a toilet flush operation.

Anionic detergents suitable for use in the toilet block compositions of the invention are powder based with good texturising properties, and are preferably linear C6-24 alkyl benzene sulphonic acids, alpha olefin sulphonates and/or natural detersive agents. Suitable natural detersive agents include saponified fatty acids having an anionic function, such as coconut soap powder, tallow soap powder, palm soap powder, palm kernel soap powder, soaps based on soya oil and/or sunflower oil, and mixtures of any of these. More preferably, the anionic detergents are the sodium salt of linear C6-24-alkyl benzene sulphonic acid (sodium LABSA), sodium lauryl sulphate and/or soap nut powder. Especially preferred is when the alkyl chain is C10-18, more especially C14-16, such as, for example, that available under the trade name Nansa LSS 480 from Albright Wilson, UK. Preferably, the anionic detergent is present in the range of from 40 to 55 percent, more preferably about 50 percent w/w.

Non-ionic detergents suitable for use in the toilet block compositions of the invention are also powder based and are preferably alkoxylated alkyl phenols, such as an ethoxylated nonyl phenol having 2 to 5 mols, such as 3 to 4.5 mols, of ethylene oxide per molecule. More preferably, the length of the alkyl chain of these detergents is in the range of from C8 to C18, especially C14 to C18, more especially C16 to C18, for example, that having a chain length of C14 to C16 such as those available under the trade name Synperonic from ICI, UK.

Preferably, when present, the non-ionic detergent is present in the range of from 4 to 7, more preferably about 5 to 7 percent w/w.

The solubility regulator (component is preferably selected from alkali metal and alkaline earth metal chlorides and sulphates, although carbonates aluminosilicates (zeolites) and starch are also suitable. More preferably, anhydrous sodium sulphate is used. Preferably, the solubility regulator is present in the range of from 8 to 55 percent w/w.

The fragrance (component is preferably present in the range of from 1 to 16 percent w/w, such as about 6 percent w/w and may be in solid, liquid or micro-encapsulated form.

Compositions according to the invention optionally but preferably also comprise 1 to 10 percent w/w, preferably about 3 to more preferably about 5 percent of a limescale preventer or inhibitor, such as a tetrasodium salt of hydroxyethylidene-1,1-diphosphonic acid (HEDP) or of ethylene diamine tetra-acetic acid (EDTA) or salts (preferably sodium salts) of nitrilotetra-acetic, citric or gluconic acids.

Compositions according to the invention optionally but preferably also comprise 1 to 30 percent w/w, preferably 1 to 10 percent, more preferably 2 to especially about 2 percent of a foam booster and/or foam stabiliser, such as cocomonoethanolamide or a salt thereof.

Compositions according to the invention optionally but preferably also comprise 4 to 10 percent w/w, preferably 4 to more preferably 5 to 7 percent especially about 5 percent of one or more inert fillers, such as those selected from silica, bentonites and clays, starch and alkali metal sulphates and carbonates.

Preferably, silica is chosen and, more preferably, any fragrance present is adsorbed onto the silica particles.

Compositions according to the invention optionally but preferably also comprise 0.3 to 10 percent w/w, preferably 0.3 to more preferably 0.5 to 2 percent, especially about of a germicide or disinfectant, such as those selected from trichlorocarbanilide, triclosan, para-dichlorobenzene, para-chlorometa-xylenol. ortho-benzyl-p-dichlorophenol and benzyl cresol.

Compositions according to the invention optionally but preferably also comprise 0.01 to 10 percent w/w, preferably 5 to more preferably about 6 percent of a colourant or pigment, such as a water-dispersible or water-soluble dye.

Examples of such dyes are acid dyes, for example acid blue dyes, in liquid or solid form.

Compositions according to the invention have been found to have consistently good performance with regard to perfume-, foam- and colour-releasing properties during in-the-bowl usage, that is to say that the performance (efficiency) of the block is substantially uniform over its life.

The toilet block composition may be made by a combination of conventional steps from the known components. For example, they are conveniently formed by a process which comprises mixing, extrusion and cutting, optionally followed by compression/tabletting. Where a filler such as silica and a fragrance are used together, as is preferred, there may be an additional step comprising coating of the filler with the fragrance.

Therefore, the present invention further provides a method of manufacturing a toilet block, which method comprises extruding the composition; and optionally thereafter compressing the resulting extrusion.

The mixture to be extruded preferably contains 5-25 percent w/w by weight of a liquid component or a solid component which liquefies under extrusion conditions to act as processing aid. Such processing aids may be chosen from appropriate ingredients mentioned hereinbefore, especially the non-ionic detergent, perfume and any foam booster, or other excipients known to be effective for the purpose.

### IIIa. TOILET BLOCK COMPOSITION PIECE SIZE

Preferably the pieces of toilet block composition are sized from 1-20 mm in diameter, more preferably from 5-15 mm and most preferably around 11 mm in diameter. It will be appreciated that not all of the pieces will have exactly the same size and thus the sizes above are intended to refer to an average size. Preferably the size distribution is such that at least 90% by weight of the pieces are within 2 mm of the preferred average particle size.

The most preferred size of piece has a weight of around 0.95 g.

Preferred shapes for the pieces include cylindrical (circular, square and hexagonal), cubic/cuboid, pyramidal and spherical/ovoid. More than one kind of shape may be employed.

Most preferably the pieces are spherical/ovoid. In this case it has been found that filling of the cage with the pieces proceeds most effectively.

### IV. SILICA

Preferably the silica is present on the surface of the pieces of toilet block composition. This may arise from simple contribution by addition of the silica to the toilet block composition. Alternatively and more preferably the silica is added superficially in a stage after the formation of the pieces of toilet block composition.

The silica preferably comprises from 0.1 to 10 wt % of the toilet block composition, more preferably 0.2 to 8wt %, more preferably 0.4 to 6wt %, more preferably 0.6 to 4wt %, more preferably 1 to 3wt %, and most preferably about 2wt % of the toilet block composition.

Preferably the silica comprises a fumed silica.

A preferred silica (Aerosil® R 812 S) is commercially available from Evonik Corporation USA, Parsippany, N.J., U.S.A.). This is a hydrophobic fumed silica after being treated with organosilane (HMDS). Another preferred silica is Aerosil R208.

As an alternative to silica an agent such as tricalcium phosphate, powdered cellulose, magnesium stearate, sodium bicarbonate, alkali/alkaline ferrocyanide, aluminosilicates, Bamboo wood in particulate form may also be used.

One or more of these agents may be used as an alternative or in addition to the silica.

The silica or alternative agent preferably has a particle size of 5-50 nm. Preferably the particles are non-porous and have a surface area of 50-600 m²/g.

### V. EXAMPLES

The toilet block composition tested follows in Table 1:

TABLE 1

| Raw Material | Function | Weight Ofo |
|---|---|---|
| Sodium dodecyl benzene sulfonate (85% | Surfactant | 16-25 |
| active) | | |
| C14/C16 alpha olefin sulfonate (80% | Surfactant | 20-28 |
| active) | | |
| Sodium sulphate, anhydrous | Filler | 35-55 |
| Dried silica | Anti- | 1.5-3.0 |
| | agglomerating | |
| | agent | |
| Dye | Color | 0-2 |
| Fragrance | — | 2-9 |
| Total | | 100.00 |

The toilet block composition set forth in Table 1 was formed into spheres by compression using a mold according to the following general process:
(1) Mix the liquid components (dye and fragrance) together in a beaker using a stirrer to create a first pre-mix;
(2) Mix the powder components (the remaining ingredients) together in a mixing vessel using a stirrer to create a second pre-mix;
(3) Add the first pre-mix to the second pre-mix and mix together using a mixing vessel with a stirrer to form the composition;
(4) Add the composition to an extruder
(5) Extrude the block through the relevant die attached at the end of the extruder and cut the block by hand into the required size;
(6) (Optional (instead of cutting)) Compress the mold to form a sphere.

Different shapes were created. Each piece comprised approximately 0.95 grams of the toilet block material and had a diameter of approximately 11 mm.

After the individual smaller pieces of the toilet block composition were created, the pieces of the composition were introduced to the ITB cage in random fashion. The total weight of the toilet block pieces introduced to the cage was approximately 36 grams. The cage was filled with pieces of toilet block composition such that little to no headspace remained between the top of the composition and the top interior portion of the cage.

Turning to the examples, a cage, modified in the manner hereinbefore described, was placed in a UK toilet bowl (Brand: Cooke and Lewis; Model: Romeo; Flush litres=6 litres). The toilet was flushed at intervals of every 2 hours. After 1 week; then 2 and 3 and 4 weeks; the foam height generated in the toilet bowl was measured immediately after the flushing had ceased and then again at 30 seconds after the flushing had ceased.

To measure the height of the foam produced, a metric ruler was placed in the toilet bowl. The foam height above the water level in the toilet was then recorded. The beads are coated with two different grades of silica, with each showing beneficial results. There are no inert beads. The results are set forth in Table 2.

TABLE 2
Particle diameter = 11 mm

| Bead | Bead | Foam amount (cm) | | | | |
|---|---|---|---|---|---|---|
| Shape | Amount | 1 week | 2 weeks | 3 weeks | 4 weeks | Silica |
| Flower | 32 g | 8 | 7 | 4 | 3 | R812s |
| Oval | 32 g | 8 | 9 | 7 | n/A | R812s |
| Oval | 36 g | 7 | 8 | 8 | 4 | R812s |
| Oval | 36 g | 4.5 | 8 | 5 | n/A | R208 |
| Hexagon | 32 g | 8 | 5 | 5 | 3 | R812s |
| Triangle | 32 g | 8 | 9 | 7 | 5 | R812s |
| Circle | 32 g | 8 | 9 | 8 | 3 | R812s |

In comparison the foam height of a single block of the same formulation, formulated into a single solid block and without the inclusion of a silica was as below.

TABLE 3

| | |
|---|---|
| Composition | Foam amount (cm) |

| Amount | 1 week | 2 weeks | 3 weeks | 4 weeks |
|---|---|---|---|---|
| 32 g | 3.5 | 5 | 5 | 1.5 |
| 32 g | 3.5 | 5 | 5 | 1.5 |

It can be seen that in almost every case the foam height from the device of the invention is superior (and at worst equivalent) to a single bock of the formulation.

1. An in-the-bowl (ITB) toilet cage containing multiple pieces of a solid toilet block composition coated with silica.

2. The toilet cage according to claim 1, wherein the cage is apertured to permit ingress and/or egress of flush water.

3. The toilet cage according to claim 1, wherein the silica comprises from 0.1 to 10 wt % of the toilet block composition.

4. The toilet cage according to claim 1, wherein the pieces of toilet block composition are sized from 1-20 mm in diameter.

5. A cage according to claim 1, wherein for the pieces have a shape which is selected from: cylindrical (circular, square and hexagonal), cubic/cuboid, pyramidal and spherical/ovoid.

6. A cage according to claim 1, wherein the cage comprises from 20-40 g, the solid toilet block composition.

7. A method of treating flush water in a toilet bowl, the method comprising the step of:
contacting the flush water with multiple pieces of a solid toilet block composition coated with silica in the in-the-bowl (ITB) toilet cage of claim 1.

8. The method of claim 7 wherein the flush water contacting the multiple pieces of a solid toilet block composition form a foam in the flush water
